(19) United States
(12) Patent Application Publication
(10) Pub. No.: US 2025/0220611 A1
(43) Pub. Date: Jul. 3, 2025

(54) Synchronizing Restricted Traffic Window Service Periods Across Bands for Non-Simultaneously Transmit and Receive (NSTR) Stations

(71) Applicant: Cisco Technology, Inc., San Jose, CA (US)

(72) Inventors: Indermeet S. Gandhi, San Jose, CA (US); Malcolm M. Smith, Richardson, TX (US); Binita Gupta, San Diego, CA (US)

(73) Assignee: Cisco Technology, Inc., San Jose, CA (US)

(21) Appl. No.: 18/786,355

(22) Filed: Jul. 26, 2024

Related U.S. Application Data
(60) Provisional application No. 63/616,554, filed on Dec. 30, 2023.

(51) Int. Cl. H04W 56/00

(52) U.S. Cl. CPC H04W 56/0045

(57) ABSTRACT

Synchronizing restricted traffic window Service Periods (SPs) across bands for Non-Simultaneous Transmit and Receive (NSTR) stations may be provided. An Access Point (AP) may receive a first request for a first Restricted Target Wake Time (rTWT) SP from a Station (STA) on a first link established between the STA and the AP. The first request may include a first start time and a first duration of the first rTWT SP on the first link. The AP may receive a second request from the STA for a second rTWT SP on a second link established between the STA and the AP. The second request may include a second start time and a second duration of the second rTWT SP on the second link. The AP may adjust one of the first rTWT SP and the second rTWT SP to synchronize an end time of both the first rTWT SP and the second rTWT SP.

### RELATED APPLICATION

Under provisions of 35 U.S.C. § 119 (e), Applicant claims the benefit of U.S. Provisional Application No. 63/616,554 filed Dec. 30, 2023, which is incorporated herein by reference.

### TECHNICAL FIELD

The present disclosure relates generally to synchronizing restricted traffic window service periods across bands for Non-Simultaneous Transmit and Receive (NSTR) stations.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for synchronizing restricted traffic window Service Periods (SPs) across bands for Non-Simultaneous Transmit and Receive (NSTR) stations;

FIG. 2 is a flow chart of a method for synchronizing restricted traffic window SPs across bands for NSTR stations; and

FIG. 3 is a block diagram of a computing device.

### DETAILED DESCRIPTION

### Overview

Synchronizing restricted traffic window service periods across bands for Non-Simultaneous Transmit and Receive (NSTR) stations may be provided. An Access Point (AP) may receive a first request for a first Restricted Target Wake Time (rTWT) Service Period (SP) from a Station (STA) on a first link established between the STA and the AP. The first request may include a first start time and a first duration of the first rTWT SP on the first link. The AP may receive a second request from the STA for a second rTWT SP on a second link established between the STA and the AP. The second request may include a second start time and a second duration of the second rTWT SP on the second link. The AP may adjust at least one of the first rTWT SP and the second rTWT SP to synchronize an end time of both the first rTWT SP and the second rTWT SP.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Client devices, such as Stations (STA), may implement power-saving mechanisms including sleeping between Access Point (AP) beacons and waking up to transmit date. Restricted Target Wake Time (rTWT) establishes a period for STA to wake up and send and/or receive data. Using rTWT allows AP to avoid transmitting Physical Layer Protocol Data Units (PPDU) beyond a Service Period (SP) specified by a rTWT. Thus, network traffic may be more deterministic with predictable start times, fewer delays, and better support for traffic scheduling, such as the Institute of Electrical and Electronics Engineers (IEEE) 802.1Qvb traffic scheduling. This helps conserve battery power in the STA as well. However, the current rTWT implementation is link specific, that is, a Multi-Link Device (MLD) may have to request rTWT individually for each link. This prevents synchronization of the rTWT SPs across link.

Non-Simultaneous Transmit and Receive (NSTR) MLD may have separate transmit and receive chains. Due to self-interference across these chains, NSTR MLDs may either transmit (that is, Tx+Tx) or may receive (that is, Rx+Rx) on the NSTR link pairs and may require PPDU end time alignment. That is, if a STA intends to setup rTWT schedules on the two NSTR links and those overlap in time, then for rTWT transmissions to work on the two NSTR links, the transmit and receive packet data units (that is, PPDUs) may need to be aligned across the two NSTR links. Such alignment may require synchronizing rTWT SPs across the two NSTR links.

For example, the STA may request an rTWT SP on a first link from a time T1 to a time T2 and a separate rTWT SP on a second link from a time T3 to time T4. If the time T1 to time T2 does not overlap with the time T3 to time T4, the STA may not efficiently use NSTR links, because then only one NSTR link may be used at a time. For efficient NSTR operation where both NSTR links may be used, the STA may need to setup rTWT SPs on the two NSTR links which are aligned in their SPs. Then PPDU end time alignment is applied for transmissions on the two NSTR links with aligned SPs. Aspects of the disclosure therefore provide techniques to synchronize the rTWT SPs across NSTR links to improve efficiency.

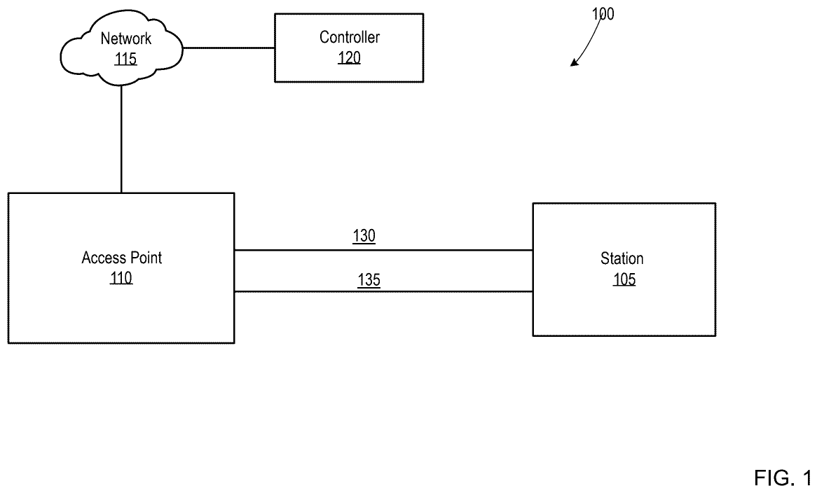

FIG. 1 shows an operating environment 100 for synchronizing restricted traffic window SPs across bands for NSTR STAs. As shown in FIG. 1, operating environment 100 may comprise a STA 105, an AP 110, a network 115, and a controller 120. However, operating environment 100 is not so limited and may include multiple APs and multiple STAs. AP 110 may be associated with one or more stations, including STA 105. AP 110 may provide an access to network 115 (e.g., a Wireless Local Area Network (WLAN)) to STA 105.

STA 105 may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

AP 110 and STA 105 may use Multi-Link Operation (MLO) where they simultaneously transmit and receive across different bands and channels by establishing two or more links, for example, a first link 130 and a second link 135, to two or more AP radios. These bands may comprise, but are not limited the 2 GHz band, the 5 GHz band, the 6 GHz band, and the 60 GHz band. First link 130 and second link 135 may be in different bands, for example, 5 GHz and 6 GHz band respectively. STA 105 may also be a NSTR device, unable to simultaneously transmit and receive. That is, for MLD communications with AP 110, STA 105 may need to receive PPDUs from AP 110 that have aligned end times.

Controller 120 may comprise a WLAN controller and may provision and control operating environment 100 (e.g., the WLAN). Controller 120 may allow the plurality of user devices to join operating environment 100. In some embodiments of the disclosure, controller 120 may be implemented by a Digital Network Architecture Center (DNAC) controller (i.e., a Software-Defined Network (SDN) controller) that may configure information for operating environment 100 in order to synchronize restricted traffic window SPs across bands for STA 105 consistent with embodiments of the disclosure.

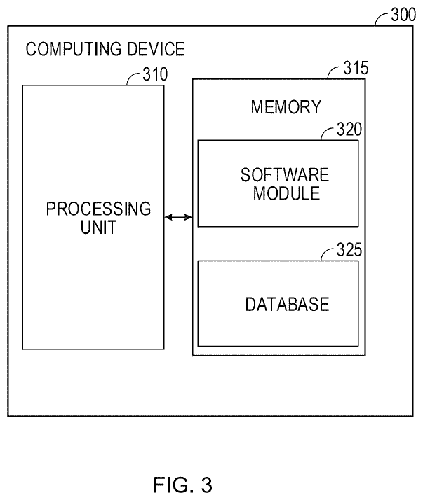

The elements described above of operating environment 100 (e.g., STA 105, AP 110, and controller 120) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

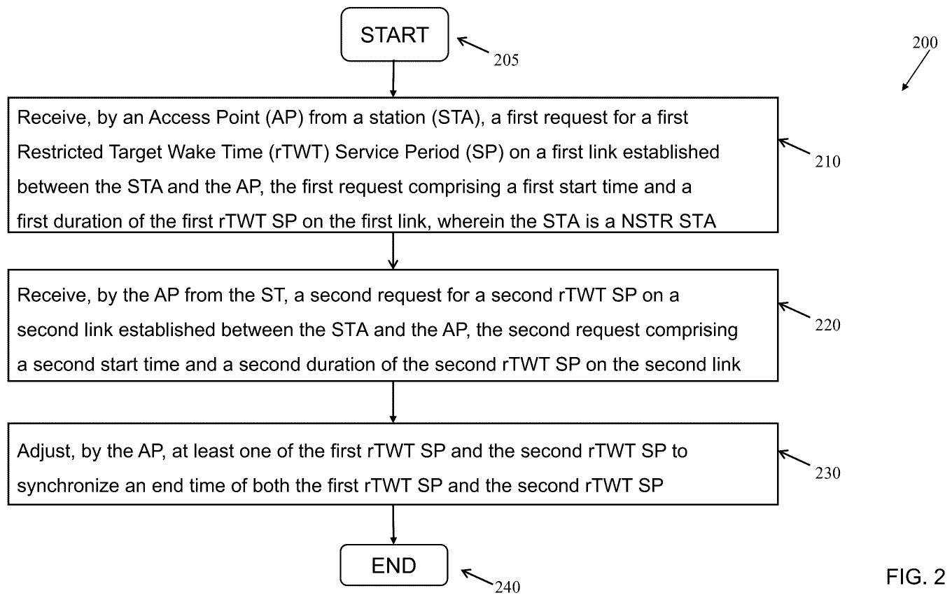

FIG. 2 is a flow chart of a method 200 for synchronizing restricted traffic window SPs across bands for NSTR STAs, for example, STA 105. Method 200 may be implemented using AP 110 as described in more detail above with respect to FIG. 1. However, method 200 may be implemented using any of STA 105 and controller 120 as described in more detail above with respect to FIG. 1. Ways to implement the stages of method 200 will be described in greater detail below.

Method 200 may begin at starting block 205. In some embodiments, method 200 may begin in response to STA 105 receiving a beacon from AP 110. For example, STA 105 may send a request for data, a request to connect to network 115, and/or perform another operation for connecting and/or accessing network 115. In response to determining that STA 105 may need to be communicated with, AP 110 may send a beacon. The beacon may indicate that AP 110 supports rTWT. The beacon may further indicate that AP 110 supports for cross-band synchronization of rTWT SPs. In response to detecting the beacon, STA 105 may establish one or more links, for example, first link 130 and second link 135, with AP 110. First link 130 and second link 135 may be NSTR links and STA 105 may either transmit (that is, Tx+Tx) or may receive (that is, Rx+Rx) on first link 130 and second link 135.

After beginning at starting block 205, method 200 may proceed to stage 210 where AP 110 may receive a first request for a first rTWT SP on first link 130 established between STA 105 and AP 110. The first request may comprise a first start time and a first duration of the first rTWT SP on first link 130. The first request may also include a first link identifier for first link 130. For example, STA 105 may request a first rTWT SP on first link 130 with a first start time T1 and of a first duration D1. In another example, STA 105 may request a first rTWT SP on first link 130 from a first start time T1 to a first end time T2. The first request may also include a link identifier for first link 130, for example, a Link-id-1.

rTWT parameters for the first request may be provided in a setup frame. The setup frame, for example, may include a new Information Element (IE) having one or more fields to indicate a link identifier, a start time, and a duration for the first rTWT SP. In some examples, the rTWT parameters for the first request may be sent in an information frame. The information frame, for example, may include a new IE having one or more fields to indicate a link identifier, a start time, and a duration for the first rTWT SP.

Once having received the first request for the first rTWT SP on first link 130 at stage 210, method 200 may proceed to stage 210 where AP 110 may receive a second request for a second rTWT SP on second link 135 established between STA 105 and AP 110. The second request may comprise a second start time and a second duration of the second rTWT SP. The second request may also include a second link identifier for second link 135. For example, STA 105 may request a second rTWT SP on second link 135 with a second start time T3 and of a second duration D2. In another example, STA 105 may request a second rTWT SP on second link 135 from a second start time T3 up to a second end time T4. The second request may also include a link identifier for second link 135, for example, a Link-id-2. rTWT parameters for the second request may be provided in a set-up frame or an information frame.

First duration D1 may be same as or different from the second duration D2. Similarly, the first start time T1 may be same as or different from the second start time T3. In example embodiments, both the first request and the second request may be received simultaneously, the first request may be received before the second request, or the first request may be received after the second request. STA 105, by virtue of being an MLD or an MLO capable device may set up rTWT sessions with AP 110 on both first link 130 and second link 135 in different bands. This may allow STA 105 to exchange data on two links simultaneously thereby shortening a wake up time and conserving power.

After receiving the first request for the first rTWT SP on first link 130 at stage 210 and the second request for the second rTWT SP on second link 135 at stage 220, method 200 may proceed to stage 230 where AP 110 may adjust at least one of the first rTWT SP and the second rTWT SP to synchronize an end time of both the first rTWT SP and the second rTWT SP. For example, AP 110 may shorten or truncate the rTWT SP duration on one or both links (that is, first duration D1 and the second duration D2) to synchronize the end time of both the first rTWT SP and the second rTWT SP. In another example, AP 110 may extend, expand, or stretch the rTWT SP duration on one or both links (that is, first duration D1 and the second duration D2) to synchronize the end time of both the first rTWT SP and the second rTWT SP. In yet another example, AP 110 may adjust the start time on one or both links (that is, first start time T1 and second start time T3) to synchronize the end time of both the first rTWT SP and the second rTWT SP. In some other examples, AP 110 may adjust the start time as well as adjust the rTWT SP duration on one or both links to synchronize the end time of both the first rTWT SP and the second rTWT SP.

AP 110 may provide the adjusted rTWT SPs for each link (that is, first link 130 and second link 135) in rTWT Information or setup frames to STA 105. STA 105 may use the adjusted rTWT SP (for example, an adjusted start time and an adjusted duration) to exchange data or enable MLO. AP 110 may also provide synchronization error values if a desired or perfect alignment could not be achieved. In example embodiments, STA 105 may send another set of requests (that is, a third request and a fourth request) with the adjusted rTWT SPs to AP 110. AP 110 may then create a rTWT SP schedule based on the adjusted rTWT SPs for STA 105. Once having synchronized at least one of the first duration and the second duration at operation 230, method 200 may conclude at ending block 240.

In some embodiments, the rTWT SP schedules across multiple links of AP 110 may be shared with other APs in operating environment 100 so that STA 105 may not have to reestablish a rTWT SP schedule again on a new AP when STA 105 roams to that new AP. In addition, and as discussed above, to synchronize rTWT SPs across multiple links, a new IE may be defined in the 802.11 TWT information or setup frame. This new IE may also enable STA 105 to indicate that it wants the rTWT SPs aligned on two or more links (that is, first link 130 and second link 135). In another variant, STA 105 may not request alignment of the rTWT SPs explicitly. However, AP 110 may be configured to perform the rTWT SPs alignment for all or some specific NSTR capable STAs. Once the end time of the rTWT SPs is aligned, a PPDU end time alignment may be applied for transmissions on the two NSTR links.

FIG. 3 is a block diagram of a computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for synchronizing restricted traffic window SPs across bands for NSTR STAS as discussed with respect to FIG. 2. Computing device 300, for example, may provide an operating environment for STA 105, AP 110, controller 120, and the like. STA 105, AP 110, controller 120, and the like may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving, by an Access Point (AP) from a Station (STA), a first request for a first Restricted Target Wake Time (rTWT) Service Period (SP) on a first link established between the STA and the AP, the first request comprising a first start time and a first duration of the first rTWT SP on the first link, wherein the STA is a Non-Simultaneous Transmit and Receive (NSTR) STA;
receiving, by the AP from the STA, a second request for a second rTWT SP on a second link established between the STA and the AP, the second request comprising a second start time and a second duration of the second rTWT SP on the second link; and
adjusting, by the AP, at least one of the first rTWT SP and the second rTWT SP to synchronize an end time of both the first rTWT SP and the second rTWT SP.

2. The method of claim 1, wherein adjusting the at least one of the first rTWT SP and the second rTWT SP comprises truncating one of the first duration and the second duration to synchronize the end time of both the first rTWT SP and the second rTWT SP.

3. The method of claim 1, wherein adjusting the at least one of the first rTWT SP and the second rTWT SP comprises expanding one of the first duration and the second duration to synchronize the end time of both the first rTWT SP and the second rTWT SP.

4. The method of claim 1, wherein adjusting the at least one of the first rTWT SP and the second rTWT SP comprises changing one of the first start time and the second start time to synchronize the end time of both the first rTWT SP and the second rTWT SP.

5. The method of claim 1, further comprising sending adjusted rTWT SP to the STA.

6. The method of claim 1, further comprising receiving, by the AP from the STA, a third request for the adjusted rTWT SP on the first link and the second link.

7. The method of claim 1, further comprising providing synchronization error values if a desired alignment could not be achieved.

8. The method of claim 1, further comprising sharing rTWT SP schedule with other APs of a network.

9. A system comprising:
a memory storage; and
a processing unit coupled to the memory storage, wherein the processing unit is operative to:
receive, from a Station (STA), a first request for a first Restricted Target Wake Time (rTWT) Service Period (SP) on a first link established between the STA and an Access Point (AP), the first request comprising a first start time and a first duration of the first rTWT SP on the first link, wherein the STA is a Non-Simultaneous Transmit and Receive (NSTR) ST;
receive, from the STA, a second request for a second rTWT SP on a second link established between the STA and the AP, the second request comprising a second start time and a second duration of the second rTWT SP on the second link; and
adjust at least one of the first rTWT SP and the second rTWT SP to synchronize an end time of both the first rTWT SP and the second rTWT SP.

10. The system of claim 9, wherein the processing unit being operative to adjust the at least one of the first rTWT SP and the second rTWT SP comprises the processing unit being operative to truncate one of the first duration and the second duration to synchronize the end time of both the first rTWT SP and the second rTWT SP.

11. The system of claim 9, wherein the processing unit being operative to adjust the at least one of the first rTWT SP and the second rTWT SP comprises the processing unit being operative to expand one of the first duration and the second duration to synchronize the end time of both the first rTWT SP and the second rTWT SP.

12. The system of claim 9, wherein the processing unit being operative to adjusting the at least one of the first rTWT SP and the second rTWT SP comprises the processing unit further operative to adjust one of the first start time and the second start time to synchronize the end time of both the first rTWT SP and the second rTWT SP.

13. The system of claim 9, wherein the processing unit is further operative to:
send adjusted rTWT SP to the STA.

14. The system of claim 9, the processing unit being further operative to:
provide synchronization error values if a desired alignment could not be achieved.

15. A non-transitory computer-readable medium that stores a set of instructions which when executed perform a method executed by the set of instructions comprising:
receiving, by an Access Point (AP) from a station (STA), a first request for a first Restricted Target Wake Time (rTWT) Service Period (SP) on a first link established between the STA and the AP, the first request comprising a first start time and a first duration of the first rTWT SP on the first link, wherein the STA is a Non-Simultaneous Transmit and Receive (NSTR) STA;
receiving, by the AP from the STA, a second request for a second rTWT SP on a second link established between the STA and the AP, the second request comprising a second start time and a second duration of the second rTWT SP on the second link; and
adjusting, by the AP, at least one of the first rTWT SP and the second rTWT SP to synchronize an end time of both the first rTWT SP and the second rTWT SP.

16. The non-transitory computer-readable medium of claim 15, wherein adjusting the at least one of the first rTWT SP and the second rTWT SP comprises truncating one of the first duration and the second duration to synchronize the end time of both the first rTWT SP and the second rTWT SP.

17. The non-transitory computer-readable medium of claim 15, wherein adjusting the at least one of the first rTWT SP and the second rTWT SP comprises expanding one of the first duration and the second duration to synchronize the end time of both the first rTWT SP and the second rTWT SP.

18. The non-transitory computer-readable medium of claim 15, wherein adjusting the at least one of the first rTWT SP and the second rTWT SP comprises changing one of the first start time and the second start time to synchronize the end time of both the first rTWT SP and the second rTWT SP.

19. The non-transitory computer-readable medium of claim 15, wherein the method executed by the set of instructions further comprising:
sending adjusted rTWT SP to the STA.

20. The non-transitory computer-readable medium of claim 15, wherein the method executed by the set of instructions further comprising:
providing synchronization error values if a desired alignment could not be achieved.
